(19) United States
(12) Patent Application Publication
(10) Pub. No.: US 2010/0256012 A1
(43) Pub. Date: Oct. 7, 2010

(54) FLEXIBLE EXTRACTION METHOD FOR THE PRODUCTION OF SEQUENCE-SPECIFIC MOLECULE LIBRARIES

(75) Inventors: Markus Beier, Weinheim (DE); Stephan Bau, Darmstadt (DE); Daniel Summerer, Mannheim (DE); Mark Matzas, Heidelberg (DE); Peer F. Staehler, Mannheim (DE)

Correspondence Address: ROTHWELL, FIGG, ERNST & MANBECK, P.C., 1425 K STREET, N.W., SUITE 800, WASHINGTON, DC, 20005, US

(73) Assignee: FEBIT HOLDING GMBH, Heidelberg (DE)

(21) Appl. No.: 12/744,390

(22) PCT Filed: Nov. 24, 2008
(86) PCT No.: PCT/EP08/09951

§ 371 Date: May 24, 2010

(30) Foreign Application Priority Data
Nov. 23, 2007 (DE) 10 2007 056 398.3

(51) Int. Cl. C40B 30/04

(52) U.S. Cl. 506/9

(57) ABSTRACT

The invention relates to an extraction method for isolating target molecules from a sample with the help of a molecule library.

The invention relates to an extraction method for isolating target molecules from a sample with the use of a molecule library.

The selective extraction of molecules is a central and important process in many fields of work in biochemistry, biology and medicine. These fields of work include extraction and purification of nucleic acids, proteins, sugars and other biochemical functional molecules.

In genetics too, biochemical methods for extracting particular molecules, compounds or substance classes play an important part. Particularly important here is the purification of nucleic acids, usually DNA and RNA. Essential steps in recombination technology require isolation and purification of particular nucleic acids, for example of plasmid DNA or genomic DNA. The construction of gene libraries from messenger RNA (mRNA), which is of central importance in genetic engineering, depends on isolation of a desired RNA population. Genes or gene fragments are “fished” from such libraries in order to be able to further study or manipulate them.

The efficiency and meaningfulness of biochemical, biological and medical analytic methods can be enormously increased by miniaturization and parallelization. Such miniaturizations relate, for example, to the analysis of genetic material with the aid of hybridization experiments on DNA microarrays. The development of microarrays of suitable DNA probes as receptors enables entire genomes and transcriptomes to be analyzed. Aside from the quite widespread DNA microarrays, methods which serve the screening for molecules with particular properties, for example ribozymes, have also been miniaturized and parallelized. Further examples of receptors on microarrays are proteins and those molecules which do not naturally occur, such as peptide nucleic acids (PNAs), for example. Many of those assay formats are listed under the category biochips. All of these assay formats and biochips can potentially be utilized for isolating and purifying the sample material and for sample preparation.

Microreaction technologies may be coupled to microarrays of this kind in order to arrive at rapid and efficient systems both for sample preparation and for producing the actual array. This also includes the use of microfluidic methods.

Numerous methods for biochemical isolation of nucleic acids are available. Although the methods allow RNA or DNA to be isolated and, where appropriate, also purified via its biophysical properties, they are totally unspecific with respect to the sequence of the nucleic acid strand.

Thus it is possible to isolate relatively specifically mRNA molecules from total RNA comprising different types of RNA by immobilizing polythymidine strands (poly-T strands) on a solid phase, for example latex beads, magnetic beads, controlled pore glass beads or a column matrix. Upon the addition of total RNA, said poly-T strands hybridize with the polyadenine (poly-A) tail of mRNA molecules and allow the unbound RNA molecules to be removed. The mRNA molecules are then isolated by changing the buffer appropriately so as to stop hybridization in favor of single strands. The liberated mRNA molecules can then be eluted.

The amount of information in an isolation matrix of this kind is comparatively low, since only two categories of target molecules can be distinguished, namely those with and without poly-A tail.

A similar situation usually exists in the case of methods for isolating proteins. Thus, immunoglobulins are often isolated using an isolation matrix in a column containing immobilized protein A (from Staphylococcus aureus) (Brown et al., Biochem. Soc. Transactions (England) 26 (1998), 249). In other versions of the method, antibodies to one or a few target molecules are bound to the isolation matrix.

Isolation methods of this kind are generally referred to as affinity chromatography. A disadvantage of these methods is the fact that parallel selective isolation of different target molecules is not possible.

U.S. Pat. No. 6,013,440 describes a method for preparing an affinity matrix, which comprises immobilizing a set of different nucleic acid probes on a solid support, in order to concentrate in this way target nucleic acids of a still unknown sequence from a sample. Besides other disadvantages, it should be mentioned that the isolation matrix used in the proposed method consists of two-dimensional supports which allow only inconvenient elution. This method too, is thus incapable of removing the disadvantages known from the prior art.

WO 03/031965 describes a method and a device using as isolation matrix a microfluidic support which allows selective isolation of particular biochemical functional molecules (target molecules), in particular a sequence-specific parallel isolation of a plurality of species of target molecules, from a mixture.

The present invention relates to a method for isolating target molecules from a sample using a molecule library consisting of free capture receptors which have specific interactions with the target molecules. The method preferably comprises a parallel isolation of a plurality of target molecules using a library of a plurality of different capture receptors. The molecule library is synthesized on a solid support, in particular on a microfluidic support. The capture receptors which constitute the molecule library are detached from the support, in particular by chemical or/and physical methods, or transcribed or copied, respectively, in particular by enzymatic methods, before being contacted with the sample. The capture receptors are labeled with functional groups and then contacted with the sample in order to enable the target molecules to bind to the capture receptors which are specific for the target molecules, and to produce complexes of said target molecules and said capture receptors. The complexes formed, which consist of, for example, a capture receptor and a target molecule, are then removed from remaining sample components, preferably by immobilization to a solid phase, for example via the functional group. The target molecules bound to the solid phase can then be eluted.

The functionality of a target molecule is defined by its ability to selectively bind to a capture receptor specific for the target molecule, preferably via bioaffinity interactions such as hybridization, receptor-ligand binding, antigen-antibody binding, saccharide-lectin binding, etc.

The method of the invention comprises providing a support having a molecule library, i.e. an array of selectively binding receptors or capture probes suitable for isolating the target molecules. In a preferred embodiment, the receptors are synthesized in situ on or in the support, preferably a microfluidic reaction support. This procedure allows the molecule library to contain a very large amount of information when appropriate methods for in situ synthesis are employed. In the case of nucleic acids as target molecules, a suitable system for in situ synthesis of the corresponding capture probes can produce thousands of defined sequences of a molecule library. Thus, the invention opens a route for specifically isolating hundreds to thousands or even millions of individual DNA or RNA molecules from a mixture.

A modification of the method described above comprises contacting the sample which has a plurality of different target molecules, for example nucleic acids, with a support which has different freely choosable capture molecules reversibly bound thereto. After removing unbound or not sufficiently bound components of the sample, the complexes of target molecules and capture receptors are detached from the support. The target molecules are then removed from the capture receptors, for example via functional groups of the capture receptors that allow biophysical separation.

The method of the invention may be employed, for example, in academic research, basic research, industrial research, in quality control, in pharmaceutical research, in biotechnology, in clinical research, in clinical diagnostics, in screening methods, in diagnostics of individual patients, in clinical studies, in forensics, for genetic tests such as parenthood determinations, in animal breeding and plant cultivation or in environmental monitoring.

The invention thus relates to a method for isolating target molecules from a sample, comprising the steps of:
(a) providing a support with an array of a plurality of different freely choosable capture molecules, each of which is immobilized in a different position on or in the support,
(b) detaching the capture molecules from the support,
(c) labeling the capture molecules, wherein the labeling may be carried out before or after detaching the capture molecules according to step (b),
(d) contacting the labeled capture molecules with a sample which contains target molecules to be isolated, under conditions which enable target molecules to bind specifically to the labeled capture molecules,
(e) removing from the sample material not bound to capture molecules, and
(f) isolating the target molecules.

The invention further relates to a method for isolating target molecules from a sample, comprising the steps of:
(a) providing a support with an array of a plurality of different freely choosable capture molecule templates, each of which is immobilized in a different position on or in the support,
(b) copying the capture molecule templates in order to obtain capture molecules in a free form,
(c) labeling the capture molecules, wherein the labeling may be carried out during or after copying according to step (b),
(d) contacting the labeled capture molecules with a sample which contains target molecules to be isolated, under conditions which enable target molecules to bind specifically to the labeled capture molecules,
(e) removing from the sample material not bound to capture molecules, and
(f) isolating the target molecules.

The invention still further relates to a method for isolating target molecules from a sample, comprising the steps of:
(a) providing a support having an array of a plurality of different freely choosable capture molecule templates which are labeled and in each case immobilized in different positions on or in the support,
(b) contacting the labeled, immobilized capture molecules with a sample comprising target molecules to be isolated, under conditions which enable target molecules to bind specifically to the labeled, immobilized capture molecules,
(c) removing from the sample material not bound to capture molecules,
(d) detaching the capture molecules and target molecules bound thereto from the support, and
(e) isolating the target molecules.

The target molecules isolated by the method of the invention are preferably selected from biological polymers such as nucleic acids, for example double-stranded or single-stranded DNA molecules, for example genomic DNA molecules or cDNA molecules, or RNA molecules, polypeptides such as, for example, proteins, glycoproteins, lipoproteins, nucleoproteins, etc., peptides and saccharides.

The target molecules are preferably nucleic acids, and the capture molecules are selected from hybridization probes complementary thereto. The hybridization probes may likewise be nucleic acids, in particular DNA molecules, but may also be nucleic acid analogs such as peptide nucleic acids (PNAs), locked nucleic acids (LNAs), etc. The length of the hybridization probes preferably corresponds to 10-100 nucleotides, and said hybridization probes need not entirely consist of building blocks with bases, i.e. they may also contain, for example, abasic building blocks, linkers, spacers, etc. The hybridization probes or their complements may be bound to the support at the 3′ end, the 5′ end, or in between or in multiple positions.

Another preferred example of capture molecules are peptides. It is furthermore also possible, of course, to use libraries of low molecular weight substances as receptors.

The capture molecules or capture molecule templates immobilized on the support, for example the hybridization probes, are preferably generated on the support by in situ synthesis, for example by step-by-step construction of synthetic building blocks, and are therefore freely selectable. The building blocks for said in situ synthesis may be monomers of the substance class in question, i.e. nucleotide building blocks, for example, in the case of nucleic acids. However, they may also be more complex building blocks, thus, for example, oligonucleotides or oligopeptides composed of multiple, for example, 2, 3 or 4 monomeric units.

The sample used for the method of the invention is preferably a complex sample, i.e. the target molecules must be selectively isolated from a multiplicity of similar molecular species. The sample may be a biological sample, for example a sample from a biological organism, for example from a body fluid, a sample from a cell culture or a culture of microorganisms, etc. The sample may furthermore also come from synthetic sources, for example from a synthesis apparatus, or may be a mixture of biological and synthetic material. The use of prefabricated molecule libraries which may contain specific target molecules is also possible.

The sample may, where appropriate, be processed prior to being contacted with the receptors, for example by enzymatic reaction such as amplification, restriction cleavage, labeling, transcription, translation, fractionation, preliminary purification, etc. The target molecules to be isolated may thus be present in a labeled or unlabeled form.

The array comprising the capture molecules or capture molecule templates in immobilized form is preferably provided on a structured support, particularly preferably on a support with channels, for example with closed channels. Examples of the channels are microchannels having a 10-10 000 μm cross section. Examples of suitable supports with channels are described in WO 00/13017 and WO 00/13018. Preference is given to using a support which is optically transparent or/and electrically conductive, at least partially within the region of the positions with the immobilized capture molecules or capture molecule templates. As an alternative, however, it is also possible to use other kinds of supports, for example planar supports such as microscopy slides, for example, which enable defined molecule libraries of capture molecules to be produced.

The support employed for the method of the invention comprises an array having a plurality of different species of immobilized capture molecules or capture molecule templates, for example with at least 10, preferably at least 100, particularly preferably at least 1000, different species of capture molecules or capture molecule templates. The individual immobilized species differ in that they have a different structure, for example nucleic acid sequence, and, where appropriate, bind different target molecules—in the case of capture molecules—, and result in different capture molecules upon copying—in the case of capture molecule templates. The capture molecules or capture molecule templates are preferably constructed step by step in situ on or in the support by location- or/and time-specifically coupling synthetic building blocks in the in each case predetermined positions.

Only a single capture molecule species or capture molecule template species or a mixture of a plurality of different capture molecule species or capture molecule template species can be immobilized or synthesized in one predetermined position. It is possible, for example, to use mixtures of species which are specific for the same target molecule to be isolated, for example a set of different hybridization probes for isolating a single particular target nucleic acid. As an alternative it is also possible to synthesize the capture molecules externally and then immobilize them on the support, for example by spotting.

In a preferred embodiment, the support is integrated in an apparatus comprising a programmable light source matrix, a detector matrix, a support preferably arranged between light source matrix and detector matrix, and also means for supplying fluids into the support and for discharging fluids from the support. The programmable light source matrix or illumination matrix may be a reflection matrix, a light valve matrix, for example an LCD matrix, or a self-emitting illumination matrix. Light matrices of this kind are disclosed in WO 00/13017 and WO 00/13018. The detector matrix may, where appropriate, be integrated in the support body.

The in situ construction of capture molecules on the support may comprise fluidochemical steps, photochemical steps, electrochemical steps, or combinations of two or more of these steps. An example of an electrochemical synthesis of capture molecules on a support is described in DE 101 20 633.1. An example of a hybrid method comprising the combination of fluidochemical steps and photochemical steps is described in DE 101 22 357.9.

The method of the invention is also suitable for producing a plurality of libraries of capture molecules on a single support. Thus the detachment of capture molecules or the copying of capture molecule templates may be followed by a further synthesis-detachment or synthesis-copying cycle. In this way it is possible to isolate also very different molecular species such as mRNA molecules or DNA sequences on using one support. Switching to new target molecules using a single support is also possible. The method is well suited to automation and may be combined with further subsequent processing steps such as an amplification reaction, for example by using a PCR thermocycler, a detection or an in vitro translation.

In a first embodiment of the method of the invention, the capture molecules which can bind specifically to the target molecules are provided directly on the support. In this embodiment of the invention, the capture molecules are coupled via a cleavable bond to the support so as to enable the capture molecules to be detached from the support, for example by photochemical or/and fluidochemical steps. To this end, preference is given to providing for photolabile or/and chemically labile bonds, for example bonds cleavable by acids, bases or/and reduction, between the capture molecule and the support. The capture molecules are labeled prior to or after being detached from the support. This is carried out preferably by introducing one or more functional groups. These functional groups may be introduced, for example, during synthesis in the form of functionalized synthetic building blocks or/and after the synthesis (on the support or after detaching) by reacting the capture molecule with suitable functional groups.

In a further embodiment, the invention provides a support having immobilized capture molecule templates. On said support, the capture molecules are produced in a free form by copying the templates, preferably by means of enzymatic methods, for example by enzymatic elongation of primer molecules which bind, for example hybridize, to subsequences of the templates, or by means of other methods, as described, for example, in WO 2005/051970, the disclosure of which is hereby made a subject matter of the present application. In this embodiment, the capture molecule templates are preferably nucleic acids, and the capture molecules are nucleic acid molecules complementary thereto. Labeling groups may be introduced into the capture molecules during production, for example during enzymatic synthesis, for example by using primer molecules and/or synthetic building blocks derivatized with functional groups, or after production of the capture molecules by derivatization with suitable reactive functional groups.

After the capture molecules have been eluted from the support, the molecule library consisting of the capture receptors may also be amplified. Preference is given here to using a distortion-free amplification method which preserves the original composition of the molecule library. An example of this is emulsion PCR. In this embodiment, the functional groups intended for labeling may be introduced, for example, by using labeled amplification primers or labeled nucleoside triphosphate derivatives.

In yet another modified embodiment of the invention the capture molecules are provided directly on the support, it being possible for them to be coupled via a cleavable bond to the support—as described above. The immobilized capture molecules have been labeled by one or more introduced functional groups—as described above.

The immobilized labeled capture molecules are then contacted with the sample to be investigated, with the target molecules present in the sample binding to the immobilized capture molecules. The remaining sample components may be removed, for example by rinsing the support. Complexes of the capture molecules and the target sequences are then detached from the support, from which complexes said target molecules can be isolated. In this embodiment, the capture molecules immobilized on the support may be contacted with the sample under conditions of variable stringency, for example stringent or less stringent hybridization conditions, for target molecules having weaker interactions with the immobilized capture molecules (e.g. nucleic acid sequences with one or more mismatches) to bind or not bind to said capture molecules as a function of the given stringency. Correspondingly, it is also possible to control the separation of unwanted sample components by setting more or less stringent washing conditions. The stringency may be controlled here via temperature and/or buffer composition.

The functional groups used for labeling the capture molecules in the method of the invention are preferably solid phase binding groups, i.e. groups which can be bound to a suitable solid phase, for example to a further support as indicated above, a microtiter plate, a column or particulate solid phases such as beads. Preference is given to using as functional group a first partner of a bioaffinity binding pair, which can react with high affinity and specificity with the complementary second partner of the binding pair.

Examples of suitable pairs of binding partners are antigen or hapten/antibody, biotin/streptavidin, sugar/lectin, ligand/receptor, etc. In a preferred embodiment, the functional group is biotin and the complementary group of the solid phase is streptavidin or avidin. It is also possible, of course, to use biotin derivatives capable of binding to streptavidin or avidin rather than biotin.

By immobilizing functionalized capture molecules, it is also possible in the method of the invention to remove the target molecules bound to the capture molecules from other sample components, for example from components of the sample which are unable to bind to the capture molecules. The capture molecules may be immobilized on the solid phase in a location-unspecific manner but also—when using different functionalized groups—in a location-specific manner, for example on different particles or in different spatial regions of a common solid phase.

In one embodiment of the invention, a plurality of subfractions of the capture molecule library used for isolating the target molecules are produced. These subfractions which are preferably capable of binding to various species or groups of target molecules may be produced spatially separately from other subfractions on a single support, and may be detached from the support or copied spatially or/and temporally separately from other subfractions. Alternatively, subfractions of the molecule library may also be produced in each case separately on a plurality of supports. It is also possible, where appropriate, to label different subfractions of the molecule library with different functional groups. For example, a first subfraction of capture molecules may be labeled with biotin and bind to a streptavidin- or avidin-coated solid phase. Another subfraction in turn may be labeled with an antigen or hapten and bind to a solid phase coated with the corresponding antibody to said antigen or hapten.

Isolating the target molecules preferably comprises eluting the target molecules from the solid phase under conditions in which the bond of the target molecule to the capture molecule is broken but the capture molecule remains bound to the solid phase.

The target molecules immobilized to the solid phase may be eluted in a single step. On the other hand, however, elution may be carried out in a location- or/and time-specific manner, with individual target molecules or individual groups of target molecules firstly being eluted from the solid phase in a first step, and further target molecules or groups of target molecules being eluted in one or more subsequent steps.

In a particularly preferred embodiment of the invention, elution is carried out by means of a temperature change, for example a temperature increase, resulting in a denaturation of nucleic acid double strands.

The method of the invention may also be employed for isolating proteins and other molecules, in particular DNA-binding molecules, if the capture molecules selected are suitable capture probes. In a further preferred embodiment, DNA-binding proteins may therefore be isolated with the aid of DNA capture probes which may be in double- or single-stranded form. In yet another preferred embodiment it is also possible to use peptide capture probes for isolating proteins or DNA molecules. In yet another preferred embodiment, the capture probes used are nucleic acids having special binding properties, for example aptamers or ribozymes.

The isolated target molecules may be used directly or indirectly for diagnostic or therapeutic purposes. The extracted material may furthermore be used in subsequent reactions. Thus it is possible to generate from extracted nucleic acids proteins or peptides, for example by transfer into suitable vectors (cloning), or into suitable target cells (transformation or transfection), or by in vitro translation, in particular isolation of mRNA target molecules. Further examples of subsequent reactions to which the isolated target molecules can be subjected are—in particular with nucleic acid target molecules—sequencing reactions or microarray analyses.

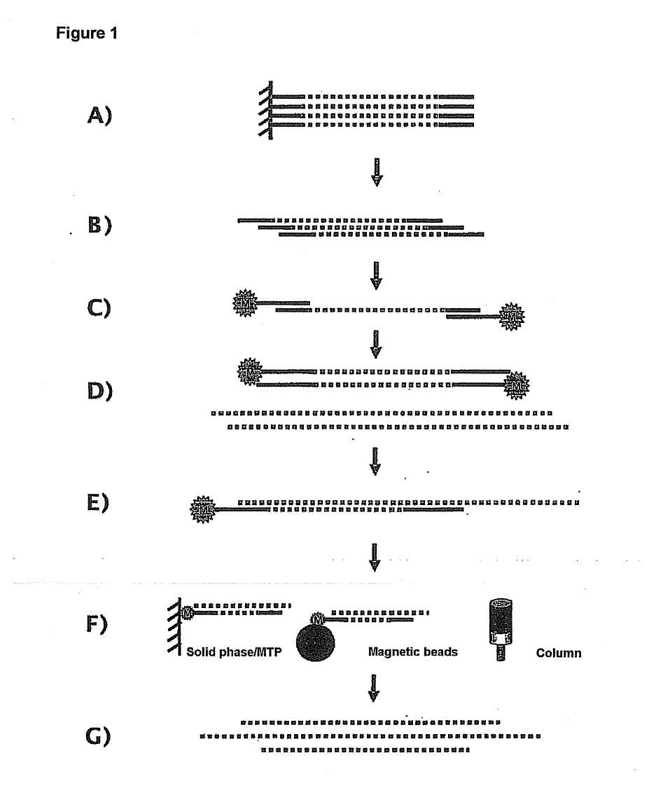

The schematic course of a preferred embodiment of the method is outlined below, using the example of nucleic acids as target molecules:
1. determination of data relating to the sequences of the target molecules to be extracted from the sample, for example genes of a model organism which is studied at the time;
2. determination of suitable capture probes complementary to regions in the selected genes, preferably with the aid of a computer;
3. preparation of the sample to be studied, for example by isolating the nucleic acid molecules from an organism;
4. providing an apparatus for in situ synthesis of appropriate capture probes in or on a microfluidic reaction support or another suitable support;
5. entering the capture probe sequence determined into a synthesis control unit which may be integrated with the support;
6. synthesizing the selected capture probe sequences in or on the support (see FIG. 1A);
7. detaching the capture probes synthesized on the microfluidic support and elution from the support (see FIG. 1B). Alternatively, the molecule library may also be obtained by way of a copying reaction of capture probe templates. This may be carried out, for example, enzymatically by way of a polymerase reaction. The result of this is, the complement of the support-bound molecule library;
8. amplification and labeling of the capture probes, synthesis of double-stranded, labeled molecules (see FIG. 1C);
9. mixing of the labeled capture probes and the sample (for example fragmented genomic DNA), in order to enable target molecules and capture probes to bind to one another (hybridize) under suitable buffer conditions and a suitable temperature (see FIGS. 1D and E);
10. immobilization of the capture probe/target molecule complexes by means of the modification (e.g. biotin) present in the capture molecule to a specific support material (such as, for example, coated magnetic beads, coated microtiter plates or a suitable column material, for example streptavidin-coated) (see FIG. 1F);
11. removing unbound or unspecifically bound components by using suitable buffer conditions and a suitable temperature;
12. detaching from the support and collecting the nucleic acid fragments to be isolated/extracted by using suitable reagents and suitable temperatures (see FIG. 1G);
13. further use of the selectively extracted nucleic acids, for example in sequencing, PCR, cloning, microarray experiments.

Where appropriate, the sample to be studied may be pretreated in order to remove particular components selectively from a sample containing a target molecule or a target molecule mixture. Interfering components may be removed, for example repetitive elements or telomer sequences when analyzing gene fragments; filtering out particular genes (e.g. housekeeping genes) in transcription analyses; protein or protein classes interfering with the proteomic analysis of (rare) proteins. Thus it is possible to capture known components by a binding to capture molecules which are specific (“negative”) to said interfering complements, and to elute only desired, for example known or unknown, target molecules, thereby concentrating desired nucleic acids or proteins or other desired biomolecules. Said pretreatment may be carried out, for example, by way of a method comprising the steps of:
(i) providing a further support having an array of a plurality of different capture molecules, each of which is immobilized in a different position on or in the support, and
(ii) passing a sample comprising target molecules to be isolated through or over the support under conditions which enable interfering components of a sample to bind specifically to the capture molecule immobilized on the support.

This procedure downgrades interfering components, thus enabling the desired molecules subsequently to be analyzed with higher precision. Furthermore, the desired target molecules of the sample to be studied are concentrated, and interfering molecules, for example multiple species in parallel, may be specifically removed from the molecule mixture.

Finally, the present invention also comprises an embodiment relating to a method for isolating target molecules from a sample, which method comprises combining at least one process cycle in which the target molecules bind to capture molecules immobilized on a support, as described in WO 03/031965, and at least one process cycle in which the target molecules bind to free labeled capture molecules.

1. A method for isolating target molecules from a sample, comprising the steps of:
(a) providing a support with an array of a plurality of different freely choosable capture molecules, each of which is immobilized in a different position on or in the support,
(b) detaching the capture molecules from the support,
(c) labeling the capture molecules, wherein the labeling may be carried out before or after detaching the capture molecules according to step (b),
(d) contacting the labeled capture molecules with a sample which contains target molecules to be isolated, under conditions which enable target molecules to bind specifically to the labeled capture molecules,
(e) removing from the sample material not bound to capture molecules, and
(f) isolating the target molecules.

2. A method for isolating target molecules from a sample, comprising the steps of:
(a) providing a support with an array of a plurality of different freely choosable capture molecule templates, each of which is immobilized in a different position on or in the support,
(b) copying the capture molecule templates in order to obtain capture molecules in a free form,
(c) labeling the capture molecules, wherein the labeling may be carried out during or after copying the capture molecules according to step (b),
(d) contacting the labeled capture molecules with a sample which contains target molecules to be isolated, under conditions which enable target molecules to bind specifically to the labeled capture molecules,
(e) removing from the sample material not bound to capture molecules, and
(f) isolating the target molecules.

3. The method as claimed in claim 1, characterized in that the target molecules are selected from nucleic acids, polypeptides, peptides and saccharides.

4. The method as claimed in claim 1, characterized in that the target molecules are selected from nucleic acids, in particular DNA molecules and/or RNA molecules.

5. The method as claimed in claim 4, characterized in that the capture molecules used are hybridization probes.

6. The method as claimed in claim 5, characterized in that the hybridization probes used are nucleic acids or nucleic acid analogs.

7. The method as claimed in claim 5, characterized in that the length of the hybridization probes corresponds to 10-100 nucleotides.

8. The method as claimed in claim 1, characterized in that a sample of biological or/and synthetic origin is used.

9. The method as claimed in claim 1, characterized in that a sample is used which has been subjected to one or more pretreatment steps.

10. The method as claimed in claim 1, characterized in that a microfluidic support is used, having closed channels, in particular having microchannels of 10-1000 μm in diameter.

11. The method as claimed in claim 1, characterized in that the array on the support comprises at least 10, preferably at least 100 positions with different capture molecules or capture molecule templates.

12. The method as claimed in claim 1, characterized in that the capture molecules or capture molecule templates in the individual positions comprise individual sequences or/and sequence mixtures.

13. The method as claimed in claim 1, characterized in that the capture molecules or capture molecule templates of the array are constructed step by step in situ on or in the support by location- or/and time-specifically immobilizing synthetic building blocks in the in each case predetermined positions.

14. The method as claimed in claim 13, characterized in that the support is used for one or more integrated synthesis-analysis cycles.

15. The method as claimed in claim 13, characterized in that the support is used together with a programmable light source matrix and a detection matrix.

16. The method as claimed in claim 1, characterized in that the capture molecules are detached from the support by photochemical or/and fluidochemical steps.

17. The method as claimed in claim 2, characterized in that
copying the capture molecule templates comprises an enzymatic polymerase reaction.

18. The method as claimed in claim 1, characterized in that labeling comprises introducing one or more functional groups, in particular solid phase binding groups, into the capture molecules.

19. The method as claimed in claim 18, characterized in that the removal of material not bound to capture molecules comprises binding to a solid phase and removing from the sample material not bound to the solid phase.

20. The method as claimed in claim 19, characterized in that isolating the target molecules comprises eluting the target molecules from the solid phase.

21. The method as claimed in claim 20, characterized in that eluting is carried out without detaching the capture molecules from the solid phase.

22. The method as claimed in claim 1, characterized in that the isolated target molecules are subjected to a subsequent reaction, for example sequencing and/or microarray analysis.

23. The method as claimed in claim 1, characterized in that the isolated target molecules are used directly or indirectly for diagnostic or therapeutic purposes.

24. A method for isolating target molecules from a sample, comprising at least one method cycle as claimed in claim 1, wherein the sample is subjected to a pretreatment step, comprising the steps of:
(i) providing a further support having an array of a plurality of different capture molecules, each of which is immobilized in a different position on or in the support, and
(ii) passing a sample comprising target molecules to be isolated through or over the support under conditions which enable interfering components of a sample to bind specifically to the capture molecules immobilized on the support.

25. A method for isolating target molecules from a sample, comprising the steps of:
(a) providing a support having an array of a plurality of different freely choosable capture molecule templates which are labeled and in each case immobilized in different positions on or in the support,
(b) contacting the labeled, immobilized capture molecules with a sample comprising target molecules to be isolated, under conditions which enable target molecules to bind specifically to the labeled, immobilized capture molecules,
(c) removing from the sample material not bound to capture molecules,
(d) detaching the capture molecules and target molecules bound thereto from the support, and
(e) isolating the target molecules.

26. (canceled)
